(19) United States
(12) Patent Application Publication
(10) Pub. No.: US 2025/0226979 A1
(43) Pub. Date: Jul. 10, 2025

(54) METHOD AND SYSTEM FOR SELF-CORRECTING KEY IN QUANTUM KEY GENERATION

(71) Applicant: QuNu Labs Private Limited, Bengaluru (IN)

(72) Inventors: Dilip Kumar Singh, Gurgaon (IN); Krishnan Rajesh Kumar, Bengaluru (IN); Shashank Gupta, Fatehpur (IN)

(73) Assignee: QuNu Labs Private Limited, Bengaluru, KA (IN)

(21) Appl. No.: 18/983,590

(22) Filed: Dec. 17, 2024

(30) Foreign Application Priority Data
Jan. 8, 2024 (IN) 202441001363

(51) Int. Cl. H04L 9/08

(52) U.S. Cl. CPC H04L 9/0861; H04L 9/0852

(57) ABSTRACT

A method for self-correcting key generation for a decoy and signal pulses based quantum key distribution (QKD) protocol includes emitting laser light; modulating intensity of the laser light to generate the decoy pulses having a first mean photon number (MPN) and the signal pulses having a second MPN greater than the first MPN; modulating phase of the signal and decoy pulses with key-generation state information and self-correction state information correlated with the key-generation state information, respectively, for being transmitted; detecting a phase and a time-stamp data of the modulated decoy and signal pulses upon being received; determining an error count using the phase and time-stamp data of at least one of the received decoy or signal pulses; and generating a self-corrected key using the self-correction state information when the error count is within a pre-determined threshold.

### TECHNICAL FIELD

The present disclosure relates to methods and systems for self-correcting key generation for a decoy and signal pulses based quantum key distribution (QKD) protocol.

### BACKGROUND

A typical quantum key distribution (QKD) protocol consists of several stages, including a preparation state, a propagation state, a detection state, a post-processing state, and a secure key generation state. In one particular QKD protocol, decoy and signal pulses are employed for the generation of a secure key. During this protocol, the decoy pulses and signal pulses are encoded with specific information. The decoy pulses are designed to aid in the detection of potential eavesdropping attempts, while the signal pulses carry the necessary information for the generation of the secure key.

Generally, such a QKD protocol is subject to channel loss, which can occur due to fibre attenuation or transmission through a noisy medium. Additionally, such QKD protocol is vulnerable to eavesdropping attacks, such as photon number splitting (PNS) attacks. These factors contribute to errors that need to be corrected during the post-processing stage. Typically, the post-processing stage involves the participation of a sender (Alice) and a receiver (Bob) in the detection of decoy and signal pulses. Thereafter, identify errors associated with the detection of these pulses and subsequently correct them to generate a secure key. However, the post-processing stage is susceptible to calculation errors that can arise from error identification and correction processes related to decoy and signal pulses. This can significantly reduce the secure key generation rate due to the time and effort involved in the post-processing stage. Consequently, said QKD protocol is associated with challenges related to poor key generation rate. Also, said QKD protocol is associated with other challenges, such as poor privacy amplification and requiring overall security enhancement.

Therefore, in light of the foregoing discussion, there exists a need to overcome the aforementioned drawbacks associated with existing QKD protocols.

### SUMMARY

The present disclosure provides methods and systems for self-correcting key generation for a decoy and signal pulses based quantum key distribution (QKD) protocol. The present disclosure provides a solution to the existing problem associated with conventional QKD protocols and provides the decoy and signal based QKD protocol having a higher key generation rate as compared to conventional QKD protocols. Typically, the aspect of self-correcting key generation precludes a need for separately identifying and correcting an error associated with the signal pulses to make a post-processing state more efficient. An objective of the present disclosure is to provide a solution that overcomes at least partially the problems encountered in the prior art and provides the decoy and signal pulses based QKD protocol configured to have a high key generation rate, improved privacy amplification and enhanced overall security.

One or more objectives of the present disclosure is achieved by the solutions provided in the enclosed independent claims. Advantageous implementations of the present disclosure are further defined in the dependent claims.

In first aspect, an embodiment of the present disclosure provides a method for self-correcting key generation for a decoy and signal pulses based quantum key distribution (QKD) protocol, the method comprising:
emitting laser light;
modulating intensity of the laser light to generate the decoy pulses having a first mean photon number (MPN) and the signal pulses having a second MPN greater than the first MPN;
modulating phase of the decoy and signal pulses for being transmitted by a sender, wherein the phase of the signal pulses is modulated based on key-generation state information and the phase of the decoy pulses is modulated based on self-correction state information correlated with the key-generation state information;
detecting a phase and a time-stamp data of the modulated decoy and signal pulses upon being received by a receiver;
determining an error count using the phase and time-stamp data of at least one of the received decoy or signal pulses by the sender; and
generating a self-corrected key using the self-correction state information by the sender and the receiver, when the error count is within a pre-determined threshold.

Optionally, the self-correction state information is correlated with the key-generation state information by syndrome data used for modulating the phase of the decoy signal pulses, the syndrome data is generated by multiplying the phase data of the signal pulses with a generator matrix.

Optionally, determining the error count comprises
sending the phase and the time-stamp data by the receiver to the sender using a classical channel therebetween; and
determining photon number specific yields of the sifted decoy or signal pulses, using the phase and the time-stamp data by the sender, based on one of a decoy gain, a signal gain, a Decoy (Quantum Bit Error Rate) QBER, a signal QBER and a dark count.

Optionally, generating the self-corrected key by the receiver comprises:
generating a raw key based the key-generation state information of the detected signal pulses, and
correcting the raw key, to generate the self-corrected key, using the self-correction state information of the detected decoy pulses.

Optionally, correcting the raw key comprises altering a bit value of the key-generation state information of the detected signal pulses based on the bit value of the self-correction state information of the detected decoy pulses to generate the self-corrected key, using the syndrome data and a parity check matrix.

Optionally, the self-corrected key is generated by iteratively altering the syndrome data and multiplying the altered syndrome data with the parity check matrix until multiplication results to zero.

Optionally, the method further comprises
hashing the self-corrected key generated by the sender,
hashing the self-corrected key generated by the receiver, and
sharing hashed values between the sender and the receiver using a classical channel therebetween to verify and have a common key.

Optionally, the method further comprises discarding generation of the self-corrected key using the self-correction state information, when the error count is above the pre-determined threshold.

Optionally, the pre-determined threshold for the error count is within the range of 10⁻³ for the 10⁹ transmitted decoy and signal pulses.

In second aspect, an embodiment of the present disclosure provides a system for self-correcting key generation for a decoy and signal pulses based quantum key distribution (QKD) protocol, the system comprising:
a sender configured to
emit laser light,
   modulate intensity of the laser light pulses to generate the decoy pulses having a first mean photon number (MPN) and the signal pulses having a second MPN greater than the first MPN, and
   modulate phase of the decoy and signal pulses for being transmitted, wherein the phase of the signal pulses is modulated based on key-generation state information and the phase of the decoy pulses is modulated based on self-correction state information correlated with the key-generation state information; and
a receiver configured to detect a phase and a time-stamp data of the modulated decoy and signal pulses upon being received,
wherein the sender is further configured to
   determine an error count for the received decoy and signal pulses using the phase and time-stamp data, and
wherein the sender and receiver are further configured to
   generate a self-corrected key when the error count is within a pre-determined threshold.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers. Moreover, numbers are only being added for convenience and should not be construed as a limitation in any way.

Embodiments of the present disclosure will now be described, by way of example only, with reference to the following diagrams wherein:

FIG. 1 illustrates steps of a method for self-correcting key generation for a decoy and signal pulses based quantum key distribution (QKD) protocol, in accordance with an embodiment of the present disclosure;

FIG. 2 illustrates a block diagram of a system for self-correcting key generation for a decoy and signal pulses based QKD protocol, in accordance with an embodiment of the present disclosure;

FIG. 3 illustrates a block diagram of a signal unit configured to generate signal pulses, in accordance with an embodiment of the present disclosure; and

FIG. 4 illustrates a block diagram of a decoy unit configured to generate decoy pulses, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides the aforementioned methods and systems for self-correcting key generation for a decoy and signal pulses based quantum key distribution (QKD) protocol. The methods and systems provide a higher key generation rate. Specifically, the aspect of self-correcting key generation causes limited involvement of a sender and a receiver during a post-processing state, which makes the key generation more efficient and in turn improves the key generation rate. For example, avoiding typical involvement of the sender and receiver in sharing detection values of the signal and decoy pulses and error correction associated therewith reduces time and process complexity associated with the post-processing. In an example, the methods and systems disclosed herein yield a significantly enhanced key generation rate, particularly evident in scenarios with a transmission distance of 100 kilometres. In a non-decoy configuration, the secure key rate substantially increases, reaching approximately 10 kilobits per second (kbps). Further, introducing decoy states further amplifies this secure key rate, allowing achievement of around 40 kbps with the same single photon detector. The implementation of self-correction mechanisms contributes to additional improvements in key rate by minimizing information leakage, subsequently reducing the necessity for privacy amplification processes. However, the methods and systems provide improved privacy amplification as well. Specifically, the methods and systems involve hashing keys and comparing hashed values for verifying generated keys, which improves the aspect of privacy amplification. Moreover, the methods and systems provide enhanced overall security. Specifically, the aspects of self-correcting key generation and the privacy amplification enhances overall security of the decoy and signal based QKD protocol. Accordingly, the methods and systems of the present disclosure provide a high key generation rate, improved privacy amplification and enhanced overall security.

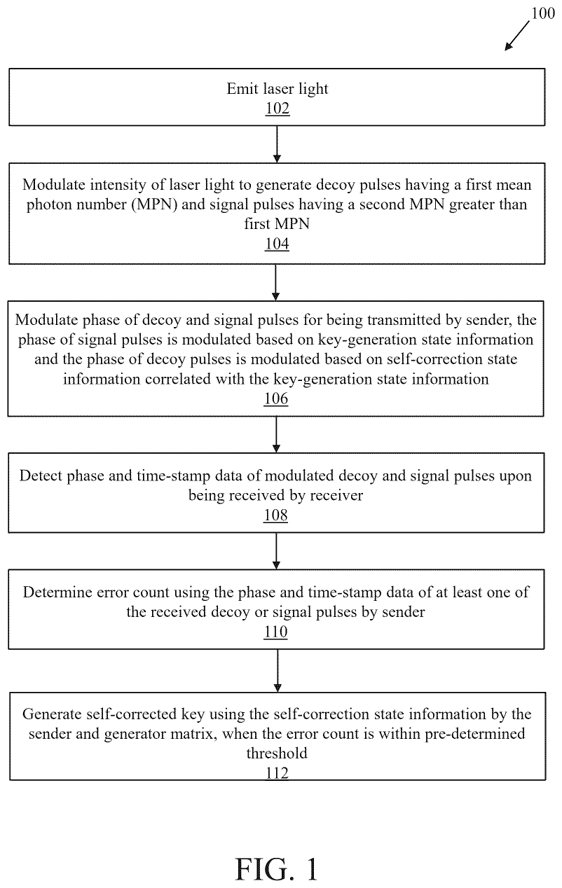

Referring now to FIG. 1, illustrated are steps of a method 100 for self-correcting key generation for a decoy and signal pulses based QKD protocol, in accordance with an embodiment of the present disclosure. At step 102, laser light is emitted. At step 104, intensity of the laser light is modulated to generate the decoy pulses having a first mean photon number (MPN) and the signal pulses having a second MPN greater than the first MPN. At step 106, phase of the decoy and signal pulses is modulated for being transmitted by a sender, wherein the phase of the signal pulses is modulated based on key-generation state information and the phase of the decoy pulses is modulated based on self-correction state information correlated with the key-generation state information. At step 108, a phase and a time-stamp data of the modulated decoy and signal pulses is detected upon being received by a receiver. At step 110, an error count is determined using the phase and time-stamp data of at least one of the received decoy and signal pulses by the sender. At step 112, a self-corrected key is generated using the self-correction state information by the sender and the receiver, when the error count is within a pre-determined threshold.

The steps 102 and 112 are only illustrative and other alternatives can also be provided where one or more steps are added, one or more steps are removed, or one or more steps are provided in a different sequence without departing from the scope of the claims herein.

It will be evident to a person skilled in the art that a typical decoy and signal pulses based QKD protocol is a method for securing communication that utilizes intensity and phase modulation of light signals. In this protocol, a sender sends a series of light signals to a receiver, with each signal encoded with a specific intensity and a phase to represent a bit value of a secure key to be generated. To prevent eavesdropping, the sender also sends decoy pulse of different intensities and phases, as compared to signal pulses, which enable the receiver to find an error associated with a quantum channel used by the sender and the receiver.

As mentioned herein above, at step 102 the laser light is emitted. In an embodiment, the laser light is emitted from the laser source. For example, the laser source may be a Weak Coherent State (WCS) laser source operable to generate a continuous beam of laser light. The WCS laser source may be a solid-state laser or a semiconductor laser, which emits the laser light. Further, the WCS laser source may be a continuous-wave laser that generates a weak, coherent beam of laser light at a specific wavelength. The specific wavelength may be typically in an infrared range of about 1530 to 1570 nanometres (nm). In an example, the laser source of the present disclosure is operable to emit the continuous beam of laser light having a wavelength of 1547.72 nm.

As mentioned herein above, at step 104, the intensity of the laser light is modulated to generate the decoy pulses having the first MPN and the signal pulses having the second MPN greater than the first MPN. According to an embodiment, the intensity of the laser light is modulated using at least one intensity modulator. The intensity modulator is a device that is operable to modulate the intensity of the laser light. In an example, the intensity modulator is an electro-optic device, which modulates the intensity of the laser light based on an applied voltage. Typically, the intensity modulator may include key components, such as, input and output ports to receive the laser light and provide modulated laser light, respectively; electrodes that are used to apply the voltage required for modulating the intensity of the laser light; and optical waveguide(s) made of high-quality optical material that acts a medium through which the laser light travels and is designed to confine the laser light within a small area to ensure efficient modulation. In an example, the intensity of the laser light is modulated using a single intensity modulator or double intensity modulators.

The term “mean photon number” refers to an average number of photons in each pulse of the laser light that is transmitted over a quantum channel between the sender and the receiver. In the present disclosure, the MPN can be calculated by dividing the total number of photons in the laser light pulses by the number of laser light pulses. The MPN can be controlled by changing an average power per pulse. For example, based on a given MPN and the laser source following Poissonian distribution, fraction of vacuum pulses, can be considered to calculate single photon pulses and multi photon pulses. It is to be understood that this does not mean that each pulse contains 0.1 photons, but rather that a probability of having a certain number of photons in each pulse is such that an average number of photons per pulse is 0.1.

The terms “decoy pulses” and “signal pulses” refer to optical pulses (or the laser light pulses) that are used to generate a secure key between two parties, i.e., sender (or Alice) and a receiver (or Bob). Typically, the signal pulses contain a secret key information that the sender wants to send to the receiver, whereas the decoy pulses are designed to provide a baseline measurement for the quantum channel, against which the signal pulses can be compared to detect any potential eavesdropping. In other words, the decoy pulses serve as a reference for the expected signal pulse behaviour, and any deviation from this behaviour can indicate the presence of an eavesdropper. In the present disclosure, the intensity of the laser light is modulated (or configured to have different MPNs) to generate the decoy and signal pulses.

The terms “first and second MPNs” mentioned herein refer to two different intensity levels or power levels of the signal and decoy pulses. These intensity levels are typically chosen to ensure that the signal pulses contain enough photons (relatively higher number of photons as compared to single photon pulses) to be detected by the receiver, while the decoy pulses are weaker and used for calibration and security purposes. In the present disclosure, the decoy and signal pulses are generated with increased and distinct MPNs, as compared to decoy and signal pulses of a conventional QKD protocol. According to an embodiment, the first and second MPNs for the modulated decoy and signal pulses, respectively, are in a range of 0.1 to 0.2 MPN and 0.5 to 0.9 MPN, respectively. For example, the at least one intensity modulator is configured to modulate the intensity levels of the laser light in a manner such that the decoy and signal pulses are modulated (or encoded) with the first and second MPNs being 0.1 and 0.5, respectively. Similarly, the decoy and signal pulses may be modulated with the first and second MPNs being 0.2 and 0.5, 0.1 and 0.6, 0.2 and 0.6, 0.1 and 0.7, 0.2 and 0.7, 0.1 and 0.8, 0.2 and 0.8, 0.1 and 0.9, or 0.1 and 0.9, respectively.

In an embodiment, the first and second MPNs are associated with the operation of the at least one intensity modulator, may be operable based on a Quantum Random Number Generator (QRNG), which generates random numbers to control the intensity of the at least one intensity modulator. In an example, the QRNG is operable to randomly select a base and a top from a transfer curve to determine bias voltages to be used for modulating the decoy and signal pulses with the first and second MPNs, respectively. In the present disclosure, the QRNG may generate random numbers, which are used to select the bias voltages that are applied to modulate the decoy and signal pulses. For example, the generation of a random number ‘0’ may cause the selection of the base of the transfer curve for the operation of the at least one intensity modulator. The selection of the base of the transfer curve is associated with a DC voltage at which an extinction ratio of the at least one intensity modulator is configured to be at its lowest, thereby causing generation of a decoy pulse modulated with the first MPN. Similarly, the generation of a random number ‘1’ may cause selection of the top of the transfer curve for the operation of the at least one intensity modulator. The selection of the top of the transfer curve is associated with a DC voltage at which an extinction ratio of the at least one intensity modulator is configured to be at its highest, thereby causing generation of a signal pulse modulated with the second MPN that is greater than the first MPN. It will be evident to a person skilled in the art that the bias voltage of the at least one intensity modulator directly controls the average optical power of the modulated signal. Accordingly, the bias voltage, the average optical power and the MPNs of the signal and decoy pulses are all related to each other through the transfer curve and the selection of the base or top by the QRNG.

According to an embodiment, the percentages of the decoy and signal pulses are in a range of 20% to 50% and 80% to 50%, respectively, based on a user-defined security threshold. It will be evident to a person skilled in the art that the security generally increases with an increase in the percentage of decoy pulses. Since, the purpose of decoy pulses is to detect potential eavesdropping attacks on a quantum channel by monitoring the characteristics of the decoy and signal pulses. Therefore, by increasing the percentage of decoy pulses, the decoy and signal pulses based QKD protocol of the present disclosure improves its ability to detect such attacks and increases the overall security of the communication. In an embodiment, the user-defined security threshold may be defined or expressed in levels such as, 1, 2, 3, 4 and 5. For example, when the user-defined security threshold is level 5 then the percentages of the decoy and signal pulses may be in a range of 50% and 50%, respectively. Similarly, when the user-defined security threshold is level 4, level 3, level 2, and level 1, then the percentages of the decoy and signal pulses may be in the range of 40% and 60%, 30% and 70%, 20% and 80%, and 10% and 90%, respectively.

As explained herein above, at step 106, phase of the decoy and signal pulses is modulated for being transmitted by a sender. According to an embodiment, the phase of the decoy and signal pulses is modulated using a phase modulator. The phase modulator encodes information in the phase of light signals (i.e., the decoy and signal pulses). For example, the phase modulator incorporates a random phase of either ‘0’ or ‘π’ for each pulse of the decoy and signal pulses received from the at least one intensity modulator, explained herein above. In an example, the phase modulator works by applying an electric field to a crystal, which changes a refractive index of the crystal. This, in turn, causes a phase shift in the decoy and signal pulses that pass through the crystal. By varying the voltage applied to the crystal, it is possible to modulate the phase of the decoy and signal pulses, which can be used to encode information. Further, in an embodiment, the phase modulator may be operated based on a QRNG, which generates random numbers to control the phase modulator. For example, the QRNG generates a random number (either ‘0’ or ‘1’) that determines a voltage to be applied to the crystal in the phase modulator, which then modulates the phase (either as ‘0’ or ‘π’) of the decoy and signal pulses.

It will be evident to a person skilled in the art that the term “sender,” as used herein, refers to a device or apparatus comprising a combination of hardware components capable of generating decoy and signal pulses. For instance, the sender may include a laser source for emitting laser light, one or more intensity modulators to modulate the intensity of the laser light, quantum random number generators, a phase modulator for modulating the phase of the decoy and signal pulses, and at least one attenuator to attenuate the modulated decoy and signal pulses for transmission according to the decoy and signal pulses-based QKD protocol. Furthermore, it should be noted that the term ‘sender’ may also be associated with an individual (e.g., Alice) utilizing the aforementioned device or apparatus.

As mentioned above, the phase of the signal pulses is modulated based on key-generation state information and the phase of the decoy pulses is modulated based on self-correction state information, which is correlated with the key-generation state information. The terms “key-generation state information” and “self-correction state information” refer to the information associated with the phase modulation of the signal and decoy pulses, which can take values of either ‘0’ or ‘π’. The specific values of ‘0’ or ‘π’ are determined, for example, using a Quantum Random Number Generator (QRNG). In simple terms, the modulation or encoding of the signal pulses with specific phase values (either ‘0’ or ‘π’) can be termed as key-generation state information. Similarly, the modulation or encoding of the decoy pulses with specific phase values (either ‘0’ or ‘π’) can be referred to as self-correction state information. Further, these phase values (either ‘0’ or ‘π’) can be expressed digitally by a series or combination of ‘0’s and ‘1’s, representing the associated bit values of the decoy and signal pulses. Therefore, a series or combination of ‘0’s and ‘1’s representing the bit values of the signal pulses is associated with a secure key to be generated and shared between the sender and receiver. However, a series or combination of ‘0’s and ‘1’s representing the bit values of the decoy pulses acts a reference for expected signal pulse behaviour, and any deviation from this behaviour can indicate the presence of an error. In the present disclosure, the self-correction state information is correlated with the key-generation state information.

According to an embodiment, the self-correction state information is correlated with the key-generation state information through syndrome data, utilized to modulate the phase of decoy signal pulses. This syndrome data is generated by multiplying the phase data of signal pulses with a generator matrix—a mathematical matrix determining the encoding of quantum states, specifically the phase data of decoy pulses. The generator matrix comprises coefficients guiding the linear combination of quantum states, transforming them into a code that forms the syndrome data. This structured transformation establishes a relationship between the phase of signal and decoy pulses transmitted from the sender to the receiver through the quantum channel. The syndrome data, analogous to error-detecting codes in classical information theory, identifies and rectifies errors that may occur during transmission. For example, if original quantum states are represented as [a, b, c], and errors occur, the resulting syndrome data [x, y, z] points out discrepancies. This information is then used to modulate the phase of decoy signal pulses. The multiplication of the phase data of signal pulses by the generator matrix (e.g., [a, b, c]*G=[x, y, z]) serves as a controlled transformation, converting raw quantum information into syndrome data.

According to an embodiment, under the QKD protocol of the present disclosure the signal pulses are followed by the decoy pulses. For example, each signal pulse may be followed by a decoy pulse, which is generally known as “decoy-state protocol”. Further, a group of signal pulses may be followed by a decoy pulse in a specific QKD protocol (BB84), which is generally known as “decoy-state BB84 protocol”. As mentioned above, phase modulation of the signal pulse(s) and the following decoy pulse would have correlated phase values (either ‘0’ or ‘π’). The correlated phase values simplify modulation and detection, reduces complexity, and enables direct comparison of statistical properties between signal and decoy pulses, which will be explained in greater detail herein later. It will be evident to a person skilled in the art that the phase modulation of the signal pulse(s) and the following decoy pulse with correlated phase values may be achieved based on operation of the phase modulator, the syndrome data, and the generator matrix. Further, a set of the “signal pulse(s) and the following decoy pulse” may be modulated randomly with a same or different phase value as compared to a prior or subsequent set of the “signal pulse(s) and the following decoy pulse.”

According to an embodiment, the modulated decoy and signal pulses may be attenuated, using at least one attenuator, for being transmitted under the decoy and signal pulses based QKD protocol. It will be evident to a person skilled in the art that the at least one attenuator may be a device that reduces the amplitude of signals (i.e., the decoy and signal pulses) without introducing any significant distortion or noise. The at least one attenuator involves using a resistive element to reduce the power level of the signal, i.e., the decoy and signal pulses. The attenuation level is determined by the ratio of the output power to the input power of the signals, which is expressed in decibels (dB).

According to an embodiment, the attenuated decoy and signal pulses from the sender (Alice) are received by the receiver (Bob) under the decoy and signal pulses based QKD protocol. For example, the receiver may include a one-bit delayed Mach-Zehnder interferometer for processing the attenuated decoy and signal pulses. It will be evident to a person skilled in the art that the one-bit delayed Mach-Zehnder interferometer is a device that splits the signal (i.e., the attenuated decoy and signal pulses) into two paths, with one path having a one-bit delay relative to the other. The receiver may further include single-photon detector(s) that are positioned at each output port of the interferometer. The single-photon detectors are configured to detect the presence of single photons, which form the fundamental building blocks of the secure key. By using a one-bit delayed Mach-Zehnder interferometer and single-photon detectors, the receiver is capable of accurately detecting photons in the received signal and generating the secure key with the sender under the decoy and signal pulses based QKD protocol of the present disclosure.

As explained herein above, at step 108, the phase and time-stamp data of the modulated decoy and signal pulses are detected upon being received by the receiver. The term “phase data” used herein refers an encoded information within the decoy and signal pulses. It indicates the specific phase values (such as ‘0’ or ‘π’) used to modulate the decoy and signal pulses, which carry the quantum information. The receiver detects the phase data by analysing the characteristics of the received optical signals (i.e., the decoy and signal pulses). This is typically achieved through techniques such as interferometric measurements or homodyne detection. By accurately determining the phase values, the receiver can decode the information encoded in the pulses. Further, the term “time-stamp data” refers to timing information associated with arrival of the decoy and signal pulses at the receiver (or detected by the receiver). It provides a reference for synchronization between the sender (Alice) and the receiver (Bob). The receiver detects and records the time-stamp data to ensure precise alignment and synchronization of the received pulses. It helps establish a common time reference and facilitates further processing and analysis of the received decoy and signal signals. Furthermore, the term “receiver” refers to the hardware assembly (device or apparatus) used for detection of the decoy and signal pulses. The receiver typically consists of various components, including photon detectors or coherent receivers, which capture the incoming optical signals, i.e., the decoy and signal pulses. These signals are then converted into electrical signals for subsequent processing and analysis. The receiver assembly also includes electronic circuits, algorithms, and software to perform tasks such as phase detection, time-stamp extraction, signal processing, and decoding of the quantum information associated with it. Moreover, it should be noted that the term ‘receiver’ may also be associated with an individual (e.g., Bob) utilizing the aforementioned device or apparatus.

At step 110, as explained herein above, the error count is determined using the phase and time-stamp data of at least one of the received decoy or signal pulses by the sender. According to an embodiment, the error count is determined by performing sending (or sifting) the phase and time-stamp data by the receiver to the sender using a classical channel therebetween. The term “classical channel” used herein refers to a communication pathway that conveys classical (non-quantum) information. This classical information is encoded using classical bits, which can exist in one of two states: 0 or 1. In an example, the classical channels may include the internet. The error count further includes determining photon number specific yields of the sifted decoy or signal pulses, using the phase and the time-stamp data by the sender, based on one of a decoy gain, a signal gain, a Decoy (Quantum Bit Error Rate) QBER, a signal QBER and a dark count. The term “error count” refers to the number of discrepancies or errors detected with respect to the received decoy and signal pulses at the receiver's end. In an example, the receiver simply discards the time-stamp data where no-detection happened or found. It quantifies a level of inaccuracies or deviations between the transmitted and received information (signal and decoy pulses), serving as a measure of the fidelity and reliability of the communication for secure key generation. For example, the error count could indicate a measure of inaccuracies or deviations between the transmitted and received information based on the eavesdropping attacks or calculation error.

According to an embodiment, the sender requests the phase and time-stamp data associated with the received decoy and signal pulses from the receiver. The receiver provides the phase data, which represents the specific phase value of the detected pulses, and the time-stamp data, which indicates the precise timing of each detected pulse. The sender then performs a comparison between the transmitted and received pulses, aligning the time-stamp data, and matching the phase data of the transmitted pulses with the received pulses. The matching phase and time-stamp data correspond to the successfully transmitted and received signal and decoy pulses, which are identified as detected decoy and signal pulses. These detected decoy and signal pulses form the basis for error count calculations and subsequent steps in key generation.

According to an embodiment, the error count is associated with the photon number-specific yields of the detected decoy and signal pulses. The term “photon number-specific yields” refer to specific probabilities of detecting photons within a set of sifted decoy or signal pulses. In other words, the “photon number-specific yields” involve evaluating the statistical occurrence of different photon numbers within the sifted decoy or signal pulses. These yields can be obtained by analysing the phase and time-stamp data, and considering factors such as the decoy gain, signal gain, decoy QBER, signal QBER, and dark count. In other words, the photon number specific yields may be calculated using one of the decoy gain, the signal gain, the decoy QBER, the signal QBER, and the dark count.

It will be evident to a person skilled in the art that the term “decoy gain” is related to performance and reliability of the decoy pulses employed under the protocol of the present disclosure. In other words, the decoy gain is determined by calculating a ratio of a total number of detections in both single photon detectors (at the sender and receiver ends) corresponding to the decoy pulses to the total number of decoy pulses sent by the sender. Accordingly, the error count may be determined by comparing the transmitted and received decoy pulses, utilizing their phase and time-stamp data. Further, the error count enables evaluating the fidelity of the transmitted decoy pulses by measuring the number of erroneous detections or clicks in relation to the total number of decoy clicks detected. The higher the decoy gain, the more reliable the decoy pulses, and consequently, the lower the potential error count. In other words, a higher signal gain implies a higher number of correctly received signal pulses, resulting in a lower number of erroneous detections or clicks. Consequently, a lower error count indicates better fidelity in the transmission of the decoy pulses. Therefore, a higher decoy gain indicates a higher level of security and accuracy of the protocol of the present disclosure.

Similarly, it will be evident to a person skilled in the art that the term “signal gain” is related to performance and reliability of the signal pulses employed under the protocol of the present disclosure. In other words, the signal gain is determined by calculating a ratio of a total number of detections in both single photon detectors (at the sender and receiver ends) corresponding to the signal pulses to the total number of signal pulses sent by the sender. Accordingly, the error count may be determined by comparing the transmitted and received signal pulses, utilizing their phase and time-stamp data. Further, the error count enables in evaluating the fidelity of the transmitted signal pulses by measuring the number of erroneous detections or clicks in relation to the total number of signal clicks detected. The higher the signal gain, the more reliable the signal pulses, and consequently, the lower the potential error count. In other words, a higher signal gain implies a higher number of correctly received signal pulses, which leads to a reduced number of erroneous detections or clicks. Consequently, a lower error count is indicative of better fidelity in the transmission of the signal pulses. Therefore, a higher signal gain indicates a higher level of security and accuracy of the protocol of the present disclosure.

Further, it will be evident to a person skilled in the art that the term “decoy QBER” is a crucial metric associated with the accuracy of the decoy pulses used in accordance with the protocol of the present disclosure. The decoy QBER is expressed as a percentage, i.e., calculated by dividing the number of erroneous decoy clicks detected by the total number of decoy clicks detected and multiplying the result by 100. As previously discussed, the decoy QBER provides a quantifiable measure of the error count specifically related to the decoy pulses. By calculating the ratio of erroneous decoy clicks to the total decoy clicks, the decoy QBER indicates the percentage of decoy pulses that were detected incorrectly during transmission. Therefore, a higher decoy QBER indicates a larger percentage of erroneous decoy clicks, which in turn signifies a higher error count in the transmission of decoy pulses.

Further, it will be evident to a person skilled in the art that the term “signal QBER” is a crucial metric associated with the accuracy of the signal pulses used in accordance with the protocol of the present disclosure. The signal QBER is expressed as a percentage, i.e., calculated by dividing the number of erroneous signal clicks detected by the total number of signal clicks detected and multiplying the result by 100. As previously discussed, the signal QBER provides a quantifiable measure of the error count specifically related to the signal pulses. By calculating the ratio of erroneous signal clicks to the total signal clicks, the signal QBER indicates the percentage of signal pulses that were detected incorrectly during transmission. Therefore, a higher signal QBER indicates a larger percentage of erroneous signal clicks, which in turn signifies a higher error count in the transmission of signal pulses.

Moreover, it will be evident to a person skilled in the art that the term “dark count” refers to an undesired detection of signals by photon detectors in the absence of any signal or decoy pulses. For example, the dark count may be a measure of the background noise or spurious signals that can be detected by the detectors and may occur due to various factors such as thermal noise, electronic noise, or cosmic rays. The dark count is calculated by counting the total number of detections in a specific time period when a source power is set to zero, meaning no actual pulses are being transmitted (i.e., the laser source is turned off). The dark count is typically expressed as the number of detections per second. Accordingly, the dark counts are associated with the error count, since dark counts represent false detections that contribute to an overall error rate. For example, a higher dark count indicates a higher likelihood of spurious detections and can lead to a higher error count, which in turn affects the fidelity and accuracy of the protocol. Therefore, by considering the dark counts in the error count calculation, the impact of background noise and false detections on the reliability and security of the communication can be accurately assessed.

As explained herein above, at step 112, the self-corrected key is generated using the self-correction state information by the sender and the receiver, when the error count is within the pre-determined threshold. The term “self-corrected key” refers to a cryptographic key that is generated and refined by the sender in a self-contained manner with minimal involvement from the receiver. Specifically, the generation of the “self-corrected key” precludes a need for sharing around 15% detection data by the receiver with the sender for error detection and correction. The self-corrected key is generated by the sender using the self-correction state information, i.e., information associated with the phase modulation of the decoy pulses, which will be explained in greater detail herein later.

In an embodiment, the pre-determined threshold of the error count is a predetermined value set by the sender or the receiver or both (i.e., a by system) to determine a value or a level or percentage of acceptability of the error rate. It serves as a criterion for a self-correction process. If the calculated error count falls within the threshold, the sender proceeds with the generation of the self-corrected key. The pre-determined threshold ensures that only error counts within an acceptable range are considered for self-correction, maintaining the overall security and reliability of the protocol of the present disclosure.

In an embodiment, the pre-determined threshold for the error count is within the range of 10⁻³ for the 10⁹ transmitted decoy and signal pulses. The said pre-determined threshold indicates a specific threshold that is set as limit to an allowable error count. The pre-determined threshold is expressed as a range of 10⁻³, which means that the acceptable error count should be lower than or equal to 0.001 (or 0.1%). The pre-determined threshold represents the maximum tolerable level of errors count that may occur under the protocol of the present disclosure without compromising its performance and reliability.

It will be evident to a person skilled in the art that the error count directly relates to the photon number-specific yields, i.e., as the photon number-specific yields increase, the error count tends to decrease. Further, the photon number-specific yields are calculated using at least one the decoy gain, the signal gain, the decoy QBER, the signal QBER, and the dark count. Therefore, the pre-determined threshold and the photon number-specific yields are both indicators of the error count. If the photon number-specific yields are high, it suggests a greater proportion of successfully received photons and a lower error count. Alternatively, if the photon number-specific yields are low, it indicates a higher error rate and a greater number of erroneous detections. Accordingly, the pre-determined threshold serves as a benchmark for the desired error count, and the photon number-specific yields provide a means to evaluate whether the protocol meets the pre-demined threshold. If the photon number-specific yields fall within an acceptable range, close to the desired error rate, it indicates that the protocol is operating within a desired level of accuracy. However, if the yields are significantly lower and exceed the pre-determined threshold, it suggests a higher error rate than desired, prompting the protocol to be initiated again, which is explained later in this document.

According to an embodiment, the method 100 further comprises discarding generation of the self-corrected key using the self-correction state information, when the error count is above the pre-determined threshold. In simple words, the method 100 should be initiated again, i.e., performing the aforementioned steps of 102-112 for generating the self-corrected key, unless the error count is within the pre-determined threshold. The step of discarding generation of the self-corrected key is to ensure that the self-corrected key generation process is only carried out when the error count is within an acceptable range. By setting the pre-determined threshold for the error count, which represents the maximum permissible error count, the protocol can safeguard the quality and reliability of the self-corrected key and avoid generation of compromised key.

According to one embodiment, generating the self-corrected key by the receiver comprises generating a raw key based on the key-generation state information of the detected signal pulses. As explained herein above, the phase of the signal pulses is modulated based on the key-generation state information, and the receiver determines the phase and time-stamp data of the detected decoy and signal pulses. Accordingly, the receiver generates the raw key based on the phase and time-stamp data of the detected signal pulses. For example, the raw key may be a series of bit values (0s and 1s) generated based on the phase data of the detected signal pulses. It will be evident to a person skilled in the art that the generated raw key may include some error because of possible transmission loss or eavesdropping or calculation error or system error associated with the detected signal pulses as compared to the transmitted signal pulses. Therefore, the generated raw key may be corrected by the receiver to generate the self-corrected key.

In an embodiment, generating the self-corrected key further comprises correcting the raw key, to generate the self-corrected key, using the self-correction state information of the detected decoy pulses. It will be evident that the phase of the decoy pulses is modulated or encoded using the syndrome data, which is generated by multiplying the phase data of the signal pulses with a generator matrix. Therefore, the syndrome data may indicate the amount of noise, in the quantum channel between the sender and the receiver, due to the correlation of the phase of the signal and decoy pulses (i.e., correlation between the key-generation state information and the self-correction state information). The syndrome data is received by the receiver along with the detected decoy pluses. This information is then used to correct the raw key. The correction process is done by comparing bit values of the raw key to bit values of a self-corrected key generated by the sender based on the transmitted signal pulses. This is done by using the syndrome data, the correlation between the self-correction state information and the key-generation state information. Any bits in the raw key that do not match the self-correction state information are assumed to be errors. These errors are then corrected, resulting in the self-corrected key for the receiver.

It will be evident to a person skilled in the art that correcting the raw key also comprises determining the error count by comparing a bit value of the self-correction state information of the transmitted decoy pulses with a bit value of the self-correction state information of the detected decoy pulses, based on the time-stamped data. The discrepancy in the time-stamped data would account for the error count.

According to an embodiment, correcting the raw key to generate the self-corrected key by the receiver further comprises altering a bit value of the key-generation state information of the detected signal pulses based on the bit value of the self-correction state information of the detected decoy pulses using the syndrome data and a parity check matrix. It will be evident to a person skilled in the art that the due to the correlation between the self-correction state information with the key-generation state information by the syndrome data the detected decoy pulses can be indicative of the information that can be used to correct errors in the raw key. The parity check matrix is a mathematical function or matrix used in error detection and correction schemes. The parity check matrix is applied during the decoding process on the received quantum states to check their consistency or parity, specifically, the parity check matrix is a binary matrix derived from the generator matrix with specific properties that enable error identification and correction. By performing mathematical operations with the received states and the parity check matrix, discrepancies or errors in the transmitted quantum information can be detected. The receiver employs an iterative process to generate the self-corrected key. This involves adjusting the syndrome data, which contains information about potential errors in the received quantum states. The receiver iteratively alters the syndrome data and multiplies the adjusted data with the parity check matrix until the multiplication results in zero. Otherwise, the non-zero result pinpoints residual errors based on its specific elements and matrix properties. This information guides further syndrome alteration and subsequent multiplication iterations until a zero result is achieved, signifying the self-corrected key. The iterative self-correction, enabled by the parity check matrix, enhances the reliability of quantum communication channels, and contributes to the robustness of the quantum key distribution protocol.

It will be evident to a person skilled in the art that the generation of the self-corrected key by the sender is based on the transmitted signal pulses. Specifically, the phase of the transmitted signal pulses is modulated based on the key-generation state information responsible for generating a shared secret key between the sender and receiver. The aspect of generation of the self-corrected key by the sender is based on the pre-determined threshold of the error count, which is determined based on the phase and time-stamp data requested from the receiver. At this point in time, when both the receiver and sender have a common self-corrected key. In simple terms, the self-corrected key generated by the receiver is based on the transmitted signal pulses (modulated by the key-generation state information), based on which the sender also generates the self-corrected key. Accordingly, the sender and the receiver can use the self-corrected key as the shared secret key for securing communication by encrypting messages to be sent by the sender that only the receiver can decrypt.

According to an embodiment, the method 100 further comprises hashing the self-corrected key generated by the sender and hashing the self-corrected key generated by the receiver. Further, the method 100 comprises sharing hashed values between the sender and the receiver using a classical channel therebetween to verify and have a common key (or final secure key). The sharing of the hashed values between the sender and the receiver and verifying that the shared hashed values are same is an indication that the generated self-corrected key by the sender and the receiver is a privacy amplified common self-corrected key, same for both the sender and the receiver, which can be used under the QKD protocol explained herein for secure communication. It is evident that hashing is a technique that converts data of any length into a fixed-size string of characters, called a hash value, also known as a hash code. In the present disclosure, the hash function is from a family of universal hash functions. The universal hash functions are designed to have a low probability of collision, which means that two different input values are unlikely to map to the same hash code. For example, the universal hash functions may be one of a Rabin-Karp hash function, a rolling hash function, or a Fowler-Noll-Vo hash function.

In an exemplary embodiment, the method 100 of the present disclosure may be implemented in a following manner, for example, the sender and receiver first exchange decoy pulses and signal pulses. The decoy pulses are used to estimate the amount of noise in the quantum channel between the sender and the receiver, whereas the signal pulses are used for carrying information to be used for key generation (i.e., shared secret key). The sender then generates the self-corrected key based on the key-generation state information of the transmitted signal pulses when the error count is within the pre-determined threshold. If the error count is more than pre-determined threshold, the sender and the receiver will restart the process of key generation. Further, when the error count is within the pre-determined threshold, the receiver also generates the self-corrected key by applying the self-correction process (using the generator matrix, the syndrome data and the parity check matrix), without involving the receiver, to correct any errors in the self-corrected key generated by the receiver. Once the self-correction process is complete, the sender and receiver share a same self-corrected key. Thereafter, for privacy amplification, both the sender and receiver hash the self-corrected key. The sender and receiver then share their hashed values using a classical channel. The sender and receiver then compare their hashed values to verify that they have same key. For example, if the hashed values match, then the sender and receiver have the common key, i.e., the final secure key, which can be used for encryption or secure communication.

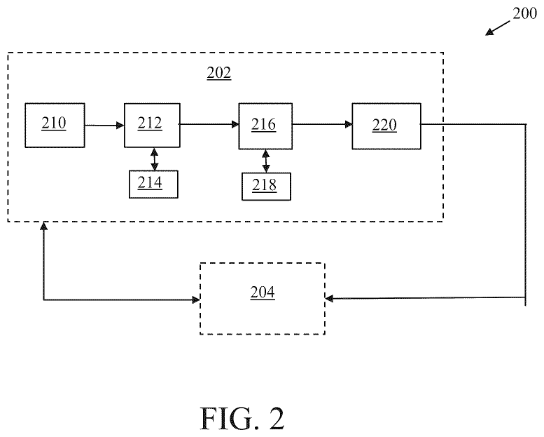

The present disclosure also relates to the second aspect as described above. Various embodiments and variants disclosed above, with respect to the aforementioned first aspect, apply mutatis mutandis to the second aspect. More specifically, various embodiments and variants disclosed above, with respect to the aforementioned method 100 (the first aspect) explained in conjunction with FIG. 1, apply mutatis mutandis to the system (the second aspect), which will be explained in conjunction with FIG. 2. It will be evident to a person skilled in the art that the system(s) of the present disclosure typically explains the implementation of the method 100 at a component or a hardware level.

Referring now to FIG. 2, illustrated a block diagram of a system 200 for self-correcting key generation for the decoy and signal pulses based QKD protocol, in accordance with an embodiment of the present disclosure. As shown, the system 200 includes a sender 202 and a receiver 204 communicably coupled to the sender 202. As show, the sender 202 includes a laser source 210, at least one intensity modulator 212, a first quantum random number generator (QRNG) 214, a phase modulator 216, a second QRNG 218; and at least one attenuator 220. The receiver 204 may include components, such as, one-bit delayed Mach-Zehnder interferometer and single-photon detectors, not shown. The sender is configured to emit laser light using the laser source 210, modulate intensity of the laser light pulses using the at least one intensity modulator 212 to generate the decoy pulses having a first mean photon number (MPN) and the signal pulses having a second MPN greater than the first MPN, and modulate the phase of the decoy and signal pulses using the phase modulator 216 for being transmitted. The phase of the signal pulses is modulated based on key-generation state information and phase of the decoy pulses is modulated based on the self-correction state information correlated with the key-generation state information. The receiver 204 is configured to detect a phase and a time-stamp data of the modulated decoy and signal pulses upon being received. The sender of the present disclosure is further configured to determine an error count for the received decoy and signal pulses using the phase and time-stamp data. The sender and receiver are further configured to generate a self-corrected key when the error count is within a pre-determined threshold.

Optionally, the system 200 is implemented with the self-correction state information correlated with the key-generation state information by syndrome data, used for modulating the phase of the decoy signal pulses, the syndrome data is generated by multiplying the phase data of the signal pulses with a generator matrix.

Optionally, the system 200 can determine the error count by sending the phase and the time-stamp data by the receiver 204 to the sender 202 using a classical channel therebetween. Thereafter, determining photon number specific yields of the sifted decoy or signal pulses, using the phase and the time-stamp data by the sender 202, based on one of a decoy gain, a signal gain, a Decoy (Quantum Bit Error Rate) QBER, a signal QBER and a dark count.

Optionally, the receiver 204 of system 200 is configured to generate the self-corrected key by generating a raw key based the key-generation state information of the detected signal pulses. Thereafter, correcting the raw key using the self-correction state information of the detected decoy pulses.

Optionally, the receiver 204 of system 200 is configured to correct the raw key by comparing altering a bit value of the key-generation state information of the detected signal pulses based on the bit value of the self-correction state information of the detected decoy pulses to generate the self-corrected key, using the syndrome data and a parity check matrix. The syndrome data is iteratively altered, and the altered syndrome data is multiplied with the parity check matrix until multiplication results to zero for generation of the self-corrected key by the receiver 204. The self-corrected key is generated by sender 202 based on the key-generation state information of the transmitted signal pulses, when the error count is within a pre-determined threshold.

Optionally, the sender 202 and the receiver 204 of system 200 are further configured to hash the self-corrected key generated by them. Thereafter, the sender 202 and the receiver 204 are configured to share hashed values using a classical channel therebetween to verify and have a common key (or a final secure key).

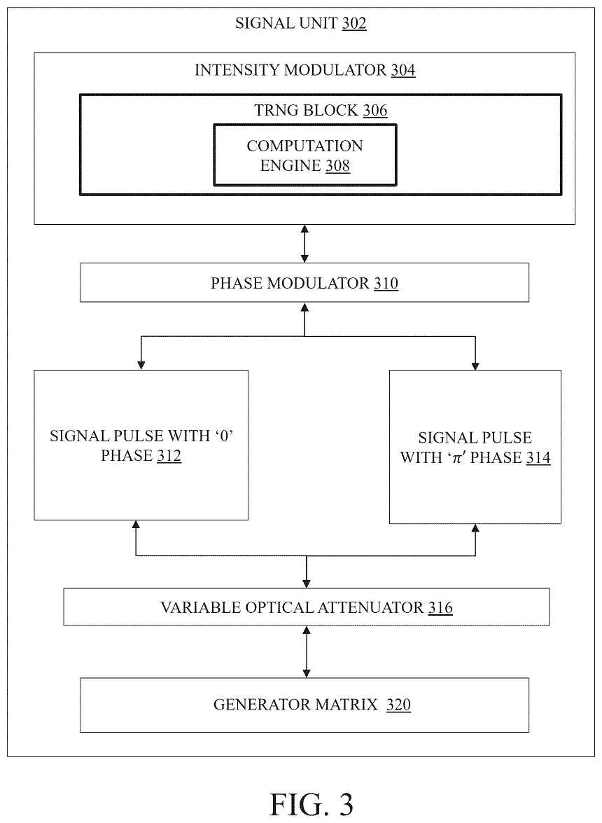

Referring now to FIG. 3, depicted is a block diagram of a signal unit 302 configured to generate signal pulses, in accordance with an embodiment of the present disclosure. It is to be understood that the signal unit 302 is typically constituted by the various components, associated with the sender 202, responsible for generating the signal pulses. For example, as shown, the signal unit 302 is associated an intensity modulator 304 (such as the intensity modulator 212) having a true random number generator block 306 (associated the first QRNG 214), and the true random number generator block 306 includes a computation engine 308. The intensity modulator 304 is operable to modulate the intensity of the laser light emitted by the sender 202 to generate the signal pulses. For example, as explained herein above, the signal pulses are modulated to have second mean photon based on truly random numbers generated by the computation engine 308 of the true random number generator block 306, ensuring unpredictability and enhancing the security of the signal pulses. The signal unit 302 is further associated a phase modulator 310 (such as the phase modulator 216) operable to randomly modulate a phase of the signal pulses to generate phase-modulated signal pulses 312 and 314 having the specific phase values, such as ‘0’ or ‘π’, respectively. The randomness of the phase modulation is based on operation of another random number generator (not shown, such the second QRNG 218). The signal unit 302 is also associated with a variable optical attenuator 316 (such as the attenuator 220) operable to receive the signal pulses 312, 314 to reduces amplitude (or power level) of the signal pulses 312, 314 prior to transmitting to the receiver 204. The signal unit 302 is further associated a generator matrix 320, which enables in correlating phase of the signal and with phase of the decoy pulses. As explained herein above, the correlation between the phase of the signal and decoy pulses is achieved with the help of the syndrome data, which is generated by multiplying the phase data of the signal pulses with the generator matrix 320.

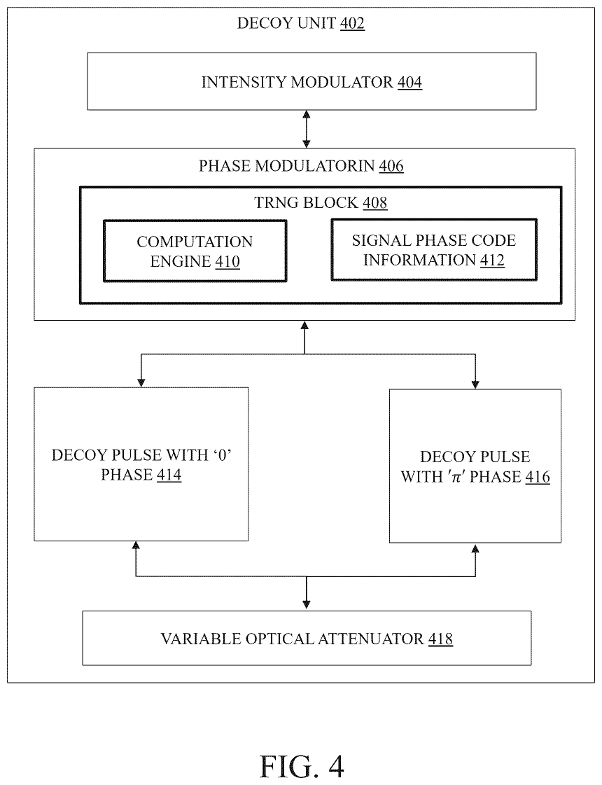

Referring now to FIG. 4, depicted is a block diagram of a decoy unit 402 configured to generate decoy pulses, in accordance with an embodiment of the present disclosure. It is to be understood that the decoy unit 402 (similar, to the signal unit 302) is typically constituted by various components, associated with the sender 202, responsible for generating the decoy pulses. For example, as shown, the decoy unit 402 is associated an intensity modulator 404 (such as the intensity modulator 212) operable to modulate the intensity of the laser light to generate the decoy pulses. For example, as explained herein above, the decoy pulses are modulated to have first mean photon based on truly random numbers generated by a quantum random number generator (not shown, such as the first QRNG 214), ensuring unpredictability and enhancing the security of the decoy pulses. The decoy unit 402 is further associated a phase modulator 406 having a true random number generator block 408 (associated the second QRNG 218). The true random number generator block 408 includes a computation engine 410, which is operable based on signal phase data 412. The phase modulator 406 is operable to modulate the phase of the decoy pulses based on the signal phase data 412 to have the correlation between phase data of the decoy and signal pulses. Specifically, the signal phase data 412 is associated with the syndrome data used for modulating the phase of the decoy pulses, and the syndrome data is generated by multiplying the phase data of the signal pulses with the generator matrix 320. The phase modulator 406 is operable to modulate the phase of the decoy pulses (in a correlated manner) to generate phase-modulated decoy pulses 414 and 416 having the specific phase values, such as ‘0’ or ‘π’, respectively. The decoy unit 402 is also associated with a variable optical attenuator 418 (such as the attenuator 220) operable to receive the decoy pulses 414, 416 to reduces amplitude (or power level) of the signal pulses 414, 416 prior to transmitting to the receiver 204.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance or illustration”. Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments”. It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A method for self-correcting key generation for a decoy and signal pulses based quantum key distribution (QKD) protocol, the method comprising:
emitting laser light;
modulating intensity of the laser light to generate the decoy pulses having a first mean photon number (MPN) and the signal pulses having a second MPN greater than the first MPN;
modulating phase of the decoy and signal pulses for being transmitted by a sender, wherein the phase of the signal pulses is modulated based on key-generation state information and the phase of the decoy pulses is modulated based on self-correction state information correlated with the key-generation state information;
detecting a phase and a time-stamp data of the modulated decoy and signal pulses upon being received by a receiver;
determining an error count using the phase and time-stamp data of at least one of the received decoy or signal pulses by the sender; and
generating a self-corrected key using the self-correction state information by the sender and receiver when the error count is within a pre-determined threshold.

2. The method as claimed in claim 1, wherein the self-correction state information is correlated with the key-generation state information by syndrome data used for modulating the phase of the decoy pulses, wherein the syndrome data is generated by multiplying the phase data of the signal pulses with a generator matrix.

3. The method as claimed in claim 2, wherein determining the error count comprises:
sending the phase and the time-stamp data by the receiver to the sender using a classical channel therebetween; and
determining photon number specific yields of the decoy or signal pulses, using the phase and the time-stamp data by the sender, based on one of a decoy gain, a signal gain, a Decoy (Quantum Bit Error Rate) QBER, a signal QBER and a dark count.

4. The method as claimed in claim 3, wherein generating the self-corrected key by the receiver comprises:
generating a raw key based the key-generation state information of the detected signal pulses, and
correcting the raw key, to generate the self-corrected key, using the self-correction state information of the detected decoy pulses.

5. The method as claimed in claim 4, wherein correcting the raw key comprises altering a bit value of the key-generation state information of the detected signal pulses based on the bit value of the self-correction state information of the detected decoy pulses to generate the self-corrected key, using the syndrome data and a parity check matrix.

6. The method as claimed in claim 5, wherein the self-corrected key is generated by iteratively altering the syndrome data and multiplying the altered syndrome data with the parity check matrix until multiplication results to zero.

7. The method as claimed in claim 6, further comprising
hashing the self-corrected key generated by the sender,
hashing the self-corrected key generated by the receiver, and
sharing hashed values between the sender and the receiver using a classical channel therebetween to verify and have a common key.

8. A system for self-correcting key generation for a decoy and signal pulses based quantum key distribution (QKD) protocol, the system comprising:
a sender configured to
emit laser light,
modulate intensity of the laser light pulses to generate the decoy pulses having a first mean photon number (MPN) and the signal pulses having a second MPN greater than the first MPN, and
modulate phase of the decoy and signal pulses for being transmitted, wherein the phase of the signal pulses is modulated based on key-generation state information and the phase of the decoy pulses is modulated based on self-correction state information correlated with the key-generation state information; and
a receiver configured to detect a phase and a time-stamp data of the modulated decoy and signal pulses upon being received,
wherein the sender is further configured to
determine an error count for the received decoy and signal pulses using the phase and time-stamp data, and
wherein the sender and receiver are further configured to
generate a self-corrected key when the error count is within a pre-determined threshold.

9. The system as claimed in claim 8, wherein the self-correction state information is correlated with the key-generation state information by syndrome data used for modulating the phase of the decoy pulses, wherein the syndrome data is generated by multiplying the phase data of the signal pulses with a generator matrix.

10. The system as claimed in claim 9, wherein determining the error count comprises:
sending the phase and the time-stamp data by the receiver to the sender using a classical channel therebetween; and
determining photon number specific yields of the decoy or signal pulses, using the phase and the time-stamp data by the sender, based on one of a decoy gain, a signal gain, a Decoy (Quantum Bit Error Rate) QBER, a signal QBER and a dark count.

11. The system as claimed in claim 9, wherein the self-corrected key is generated by
the sender based on the key-generation state information of the transmitted signal pulses, when the error count is within a pre-determined threshold, and
the receiver based on the self-correction state information of the detected decoy pulses using the syndrome data and a parity check matrix, wherein the syndrome data is iteratively altered, and the altered syndrome data is multiplied with the parity check matrix until multiplication results to zero.

12. The system as claimed in claim 11, wherein the sender and receiver are further configured to hash the self-corrected key and share hashed values between the sender and the receiver using a classical channel therebetween to verify and have a common key.
